(19) United States
(12) Patent Application Publication
(10) Pub. No.: US 2026/0093123 A1
(43) Pub. Date: Apr. 2, 2026

(54) GRATING WAVEGUIDE APPARATUS AND WAVEGUIDE SYSTEM FOR REDUCING RAINBOW PATTERNS

(71) Applicant: Beijing Greatar Tech Co., Ltd., Beijing (CN)

(72) Inventors: Erchan YANG, Hebi (CN); Yuxuan ZHAO, Beijing (CN)

(73) Assignee: Beijing Greatar Tech Co., Ltd., Beijing (CN)

(21) Appl. No.: 19/414,298

(22) Filed: Dec. 10, 2025

Related U.S. Application Data
(63) Continuation of application No. PCT/CN2025/097003, filed on May 23, 2025.

(30) Foreign Application Priority Data
May 27, 2024 (CN) 202410658035.8

(51) Int. Cl. G02B 27/01; G02B 5/18

(52) U.S. Cl. CPC G02B 27/0172; G02B 5/1823; G02B 5/1842; G02B 2027/0178

(57) ABSTRACT

The present application provides a grating waveguide apparatus and waveguide system for reducing rainbow patterns. The apparatus includes a waveguide substrate and a grating structure. The grating structure includes a first in-coupling grating and a first out-coupling grating, a grating region of the first out-coupling grating has a grating line overlapping structure with multiple dimensions; or, the grating structure includes a second in-coupling grating, a turning grating and a second out-coupling grating, a grating line region of the turning grating and a grating line region of the second out-coupling grating have an overlapping region; grating vectors of the above-mentioned grating structure form exactly one closed path in k-space.

### CROSS-REFERENCE TO RELATED APPLICATIONS

This application is a continuation of International Application No. PCT/CN2025/097003, filed on May 23, 2025, which claims priority to Chinese Patent Application No. 202410658035.8, filed on May 27, 2024, both of which are hereby incorporated by reference in their entireties.

### TECHNICAL FIELD

The present application relates to the field of augmented reality technology, specifically to a grating waveguide apparatus and waveguide system for reducing rainbow patterns.

### BACKGROUND

Augmented reality (Augmented Reality, AR) technology refers to providing users with additional information in the real world through certain technical means (that is, the so-called “augmented”). This technology organically integrates images from the virtual world and scenes from the real world, and deeply merges the calculated information with the real world, thus offering users with richer information and immersive experience.

Augmented reality technology can be realized through many hardware platforms. Among them, wearable augmented reality devices, namely AR glasses, offer the highest level of immersion. In this form factor, the hardware form is a simple pair of glasses, which introduces light into human eyes via the microstructure on the surface of lenses. This hardware implementation is the most convenient and represents a mainstream AR technology. The function of the lenses in AR glasses is to guide images from an imaging device into the human eyes through the lenses. A grating waveguide scheme is a mainstream technical solution. The grating waveguide includes a waveguide substrate, an in-coupling grating and an out-coupling grating. The in-coupling grating and the out-coupling grating are disposed on the waveguide substrate. Its basic principle is shown in FIG. 1. Light emitted from an optical engine 1 (an imaging device) is coupled into the waveguide substrate 2 by the in-coupling grating 3 and propagates within the waveguide substrate 2 via total reflection. Each time the light encounters the out-coupling grating 4, a portion of the light is coupled out. The outcoupled light rays (indicated by a solid line entering the human eyes in the figure) enter the human eyes, allowing the human to perceive the same image as the output of the optical engine 1. At the same time, the human eyes can see the real-world scene (indicated by a dashed line entering the human eyes in the figure). The superposition of two parts can achieve the function of augmented reality.

However, for AR glasses that employs grating waveguides as lenses, when users actually wear AR glasses, within an eye box range, in addition to images that enter an eye box through the out-coupling of the grating waveguide from the output of the optical engine, the human eyes can usually also observe a rainbow pattern phenomenon formed by ambient light being directly diffracted into the eye box via the out-coupling grating. As an interfering background, rainbow patterns seriously affect the viewing effect of images observed by the human eyes.

### SUMMARY

The purpose of the present application is to provide a grating waveguide apparatus and waveguide system for reducing rainbow patterns. By making grating vectors of a grating structure form exactly one closed path in k-space, a modulated beam produced by modulation of ambient light using the grating vectors is located outside a region that can be observed by human eyes, thereby achieving an effect of avoiding rainbow patterns.

In a first aspect, the present application discloses a grating waveguide apparatus for reducing rainbow patterns, including a waveguide substrate and a grating structure, and the grating structure is arranged on the waveguide substrate;
the grating structure includes a first in-coupling grating and a first out-coupling grating, a grating region of the first out-coupling grating has a grating line overlapping structure with multiple dimensions; grating vectors of the first in-coupling grating and the first out-coupling grating form exactly one closed path in k-space;
or,
the grating structure includes a second in-coupling grating, a turning grating and a second out-coupling grating, a grating line region of the turning grating and a grating line region of the second out-coupling grating have an overlapping region; grating vectors of the second in-coupling grating, the turning grating and the second out-coupling grating form exactly one closed path in k-space.

In an implementation, in the case where the grating structure includes the first in-coupling grating and the first out-coupling grating:
the waveguide substrate is provided with the first in-coupling grating and the first out-coupling grating on a same surface or on different surfaces;
the first in-coupling grating is configured as a one-dimensional grating, a two-dimensional grating or a segmented composite grating of a one-dimensional grating and a two-dimensional grating;
the first out-coupling grating is configured as a two-dimensional grating, or a segmented composite grating of a one-dimensional grating and a two-dimensional grating.

In an implementation, the two-dimensional grating is configured as a single two-dimensional grating, or a segmented composite grating of at least two two-dimensional gratings.

In an implementation, in the case where the grating structure includes the second in-coupling grating, the turning grating and the second out-coupling grating:
the turning grating and the second out-coupling grating are located on different surfaces and are arranged in parallel;
the second in-coupling grating is configured as a one-dimensional grating, a two-dimensional grating or a segmented composite grating of a one-dimensional grating and a two-dimensional grating;
the turning grating is configured as a one-dimensional grating, a two-dimensional grating or a segmented composite grating of a one-dimensional and a two-dimensional grating;
the second out-coupling grating is configured as a one-dimensional grating, a two-dimensional grating or a segmented composite grating of a one-dimensional and a two-dimensional grating;
the grating line region of the turning grating and the grating line region of the second out-coupling grating have an overlapping region in space.

In an implementation, the first in-coupling grating has a grating vector \vec{k_{Gin1}}, and the second out-coupling grating has grating vectors \vec{k₁} and \vec{k₂};
a vector sum of the grating vectors \vec{k_{Gin1}}, \vec{k₁} and \vec{k₂} is 0, and a vector sum of a horizontal component of a light vector of a projected beam of an imaging device and the grating vectors \vec{k_{Gin1}} and \vec{k₃} falls outside a first projection region, and a vector sum of the horizontal component of the light vector of the projected beam and the grating vectors \vec{k_{Gin1}} and \vec{k₂} falls within the first projection region but outside a second projection region.

In an implementation, the second in-coupling grating has a grating vector \vec{k_{Gin2}}, the turning grating has a grating vector \vec{k₃} and the second out-coupling grating has a grating vector \vec{k₄};
a vector sum of the grating vectors \vec{k_{Gin2}}, \vec{k₃} and \vec{k₄} is 0, and a vector sum of a horizontal component of a light vector of a projected beam of an imaging device and the grating vectors \vec{k_{Gin2}} and \vec{k₃} falls outside a first projection region, and a vector sum of the horizontal component of the light vector of the projected beam and the grating vectors \vec{k_{Gin2}} and \vec{k₄} falls within the first projection region but outside a second projection region.

In an implementation, the horizontal component of the light vector of the projected beam of the imaging device is a component of the projected beam in a grating waveguide plane;
the first projection region is a projection onto the grating waveguide plane of a k-space vector sphere determined by a refractive index of the waveguide substrate;
the second projection region is a projection onto the grating waveguide plane of a k-space vector sphere determined by a refractive index of air.

In an implementation, a value of a grating period is configured such that the grating vectors of the first in-coupling grating and the first out-coupling grating form exactly one closed path in the k-space; and,
a grating line direction is configured such that a projected beam of an imaging device is coupled out through the grating waveguide apparatus and enters human eyes for complete display.

In an implementation, a value of a grating period is configured such that the grating vectors of the second in-coupling grating, the turning grating and the second out-coupling grating form exactly one closed path in the k-space; and,
a grating line direction is configured such that a projected beam of an imaging device is coupled out through the grating waveguide apparatus and enters human eyes for complete display.

In an implementation, a grating region of the first out-coupling grating is positioned above a pupil in a horizontal viewing direction, a projected beam of an imaging device is incident upon the grating region of the first in-coupling grating in an oblique downward direction.

In an implementation, an overlapping region of the grating lines of the second out-coupling grating and the turning grating is positioned above a pupil in a horizontal viewing direction, a projected beam of an imaging device is incident upon a grating region of the second in-coupling grating in an oblique downward direction.

In an implementation, a grating region of the first out-coupling grating is positioned below a pupil in a horizontal viewing direction, a projected beam of an imaging device is incident upon the grating region of the first in-coupling grating in an oblique upward direction.

In an implementation, an overlapping region of the grating lines of the second out-coupling grating and the turning grating is positioned below a pupil in a horizontal viewing direction, a projected beam of an imaging device is incident upon a grating region of the second in-coupling grating in an oblique upward direction.

In an implementation, a grating region of the first out-coupling grating is positioned in front of a pupil along a horizontal viewing direction, a projected beam of an imaging device is incident upon the grating region of the first in-coupling grating in a normal incident direction.

In an implementation, an overlapping region of the grating lines of the second out-coupling grating and the turning grating is positioned in front of a pupil along a horizontal viewing direction, a projected beam of an imaging device is incident upon a grating region of the second in-coupling grating in a normal incident direction.

In an implementation, the grating vector of the first out-coupling grating has a magnitude configured such that a modulated beam resulting from modulating ambient light is directed outside a region observable by human eyes, or the grating vectors of the turning grating and the second out-coupling grating have magnitudes configured such that a modulated beam resulting from modulating ambient light is directed outside a region observable by human eyes.

In a second aspect, the present application discloses a waveguide system, including a grating waveguide apparatus;
the grating waveguide apparatus is configured as the grating waveguide apparatus for reducing rainbow patterns.

Combined with the above technical solutions, the present application provides a grating waveguide apparatus and waveguide system for reducing rainbow patterns. The grating waveguide apparatus for reducing rainbow patterns includes a waveguide substrate and a grating structure. The grating structure includes a first in-coupling grating and a first out-coupling grating, a grating region of the first out-coupling grating has a grating line overlapping structure with multiple dimensions; or, the grating structure includes a second in-coupling grating, a turning grating and a second out-coupling grating, a grating line region of the turning grating and a grating line region of the second out-coupling grating have an overlapping region. Grating vectors of the above-mentioned grating structure form exactly one closed path in k-space. Forming a single closed path with the grating vectors of the grating structure in k-space, on the one hand, ensures that the field of view (FOV) projected by an imaging device, after being subject to the grating vector effect of the grating structure within the waveguide substrate, will ultimately return to its original state. That is, when a projected image of the imaging device enters an eye box via projected beams through the grating structure of the waveguide substrate, the image displayed by the grating waveguide apparatus is distortion-free and undistorted compared to the projected image of the imaging device. On the other hand, diffracted light from ambient light that undergoes diffraction through the grating structure will not enter an eye box region, such that within an eye box range, the human eyes can only observe an image output from the imaging device and coupled out into the eye box via the grating waveguide apparatus, and will not observe the rainbow pattern phenomenon formed by ambient light being directly diffracted into the eye box through the grating structure, thereby enhancing the viewing effect of the image output by the grating waveguide apparatus for the human eyes.

### BRIEF DESCRIPTION OF DRAWINGS

FIG. 1 is a schematic diagram of a basic principle of a grating waveguide scheme.

FIG. 2 is a schematic diagram of grating vectors of an exemplary one-dimensional grating.

FIG. 3 is a schematic diagram of grating vectors of an exemplary two-dimensional grating.

FIG. 4A is a schematic diagram of k-space of light propagating in air.

FIG. 4B is a schematic diagram of k-space of light propagating in a homogeneous medium with a refractive index of n.

FIG. 5 is a schematic diagram illustrating an analysis of an example grating waveguide's effect on k-vector of light.

FIG. 6 is a schematic diagram of an in-plane component in k-space of an exemplary grating waveguide.

FIG. 7 is a schematic diagram of an exemplary k-space design of a conventional grating waveguide.

FIG. 8 is a schematic diagram of actual spatial light path propagation in a grating waveguide, exemplarily given for the schematic diagram of the k-space design of the conventional grating waveguide in FIG. 7.

FIG. 9A is a schematic diagram showing a formation principle of a rainbow pattern phenomenon when a conventional grating waveguide is used as lenses of AR glasses.

FIG. 9B is a cross-sectional view of FIG. 9A on a x-z plane.

FIG. 10 is a schematic diagram of a first example of a grating structure based on a concept of forming exactly one closed path in k-space with all grating vectors of a grating structure according to the present application.

FIG. 11 is a schematic diagram of a second example of a grating structure based on a concept of forming exactly one closed path in k-space with all grating vectors of a grating structure according to the present application.

FIG. 12 is a schematic diagram of a third example of a grating structure based on a concept of forming exactly one closed path in k-space with all grating vectors of a grating structure according to the present application.

FIG. 13 is a schematic diagram of an exemplary k-space design of a grating waveguide of the present application.

FIG. 14 is a schematic diagram of actual spatial light path propagation in a grating waveguide, exemplarily given for the schematic diagram of the k-space design of the grating waveguide of the present application as shown in FIG. 13.

FIG. 15 is a schematic diagram of an exemplary k-space design of a grating waveguide after adjustment based on FIG. 13.

FIG. 16 is a schematic diagram of actual spatial light path propagation in a grating waveguide, exemplarily given for the schematic diagram of the k-space design of the grating waveguide based on the adjustment in FIG. 15.

Among them, 1—Optical engine, 2—Waveguide substrate, 3-1—In-coupling grating, 3-2—Second in-coupling grating, 4-1—First out-coupling grating, 4-2—Second out-coupling grating, 5—Turning grating.

### DESCRIPTION OF EMBODIMENTS

First, terms involved in the present application are explained.

### Grating Vector:

A grating has a grating vector, for example:

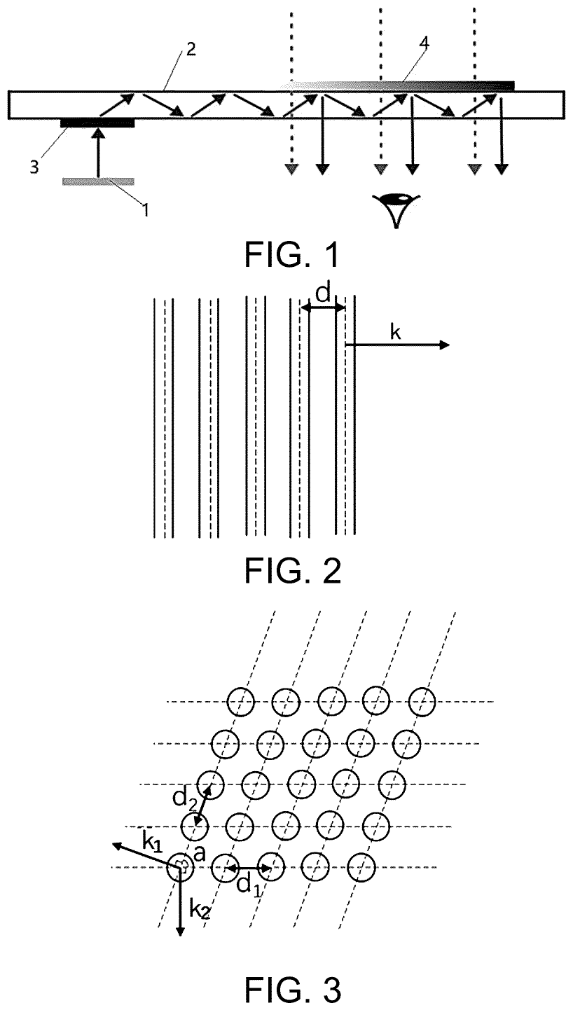

For a one-dimensional grating, as shown in FIG. 2, exemplarily, it has one grating vector, the magnitude of this gating vector is related to a grating period

$$( k = \frac{2 π}{d} ,$$

where k represents the magnitude of the grating vector of the one-dimensional grating and d is a period of the one-dimensional grating), and a direction of the grating vector is perpendicular to a grating line direction of the one-dimensional grating.

For a two-dimensional grating, as shown in FIG. 3, exemplarily, it has two grating vectors (a first grating vector and a second grating vector), the magnitude of the first grating vector is

$${k}_{1} = \frac{2 π}{{d}_{1} sin a} ,$$

and the magnitude of the second grating vector is

$${k}_{2} = \frac{2 π}{{d}_{2} sin a} ) .$$

A direction of the first grating vector is perpendicular to a grating line direction of a second-dimensional grating (with a grating period of d₂), and a direction of the second grating vector is perpendicular to a grating line direction of a first-dimensional grating (with a grating period of d₁), where d₁ is the grating period of the first-dimensional grating and d₂ is the grating period of the second-dimensional grating, a is an angle between the grating line direction of the first-dimensional grating and the grating line direction of the second-dimensional grating.

To be consistent with the case of one-dimensional grating, the magnitude of the grating vector of the two-dimensional grating is usually defined as

$$k = \frac{2 π}{{d}_{eff}} ,$$

where k represents the magnitude of the grating vector and d_{eff} represents the magnitude of a grating period component in the direction of the grating vector. For example,

$$\begin{matrix}{k}_{1} = \frac{2 π}{{d}_{1} sin a} = \frac{2 π}{{d}_{1 eff}} , \\ {k}_{2} = \frac{2 π}{{d}_{2} sin a} = \frac{2 π}{{d}_{2 eff}}\end{matrix}$$

Unless otherwise specified, the grating period in the formula related to the magnitude of the grating vector of the two-dimensional grating mentioned below is the magnitude of the grating period component in the direction of the grating vector.

A k-Space Representation of Light Propagation in a Uniform Medium:

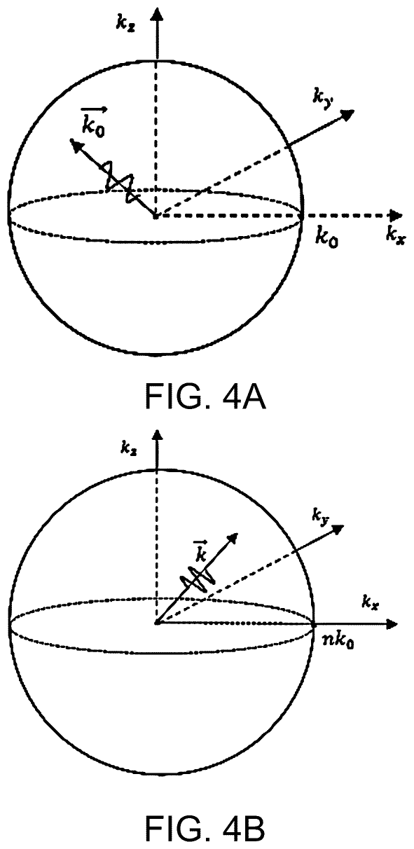

For light propagated in the uniform medium, the light propagation in the uniform medium can usually be abstracted into k-space for representation and analysis. The magnitude of a k-vector reflects a speed of light propagation in the uniform medium, while a direction of the k-vector typically represents a direction of light propagation. For the light propagation in a vacuum (or air), the magnitude of its k-vector is

$$\vert \vec{{k}_{0}} \vert = \frac{2 π}{{λ}_{0}} ,$$

where λ₀ is a wavelength of light in the vacuum (or air). For light with a wavelength of λ₀, if \vec{k₀} is used to represent a propagation state of the light in air, then all possible propagation states of the light form a sphere with a radius of k₀ (the magnitude of k₀ is |\vec{k₀}|) in k-space, as shown in FIG. 4A. In the figure, kₓ represents a unit vector of a x-direction component. k_{y} represents a unit vector of a y-direction component, and k_{z} represents a unit vector of a z-direction component. Each point on the sphere represents a propagation state of the light, and a propagation direction of the light is a vector direction from a center of the sphere to a point on the sphere. Similarly, if k represents a propagation state of light in a uniform medium with a refractive index of n, all possible propagation states of the light would form a sphere in k-space with a radius of nk₀ (the size of nk₀ is n|\vec{k₀}|), as shown in FIG. 4B.
Analysis of a Grating Waveguide's Effect on the k-Vector of Light:

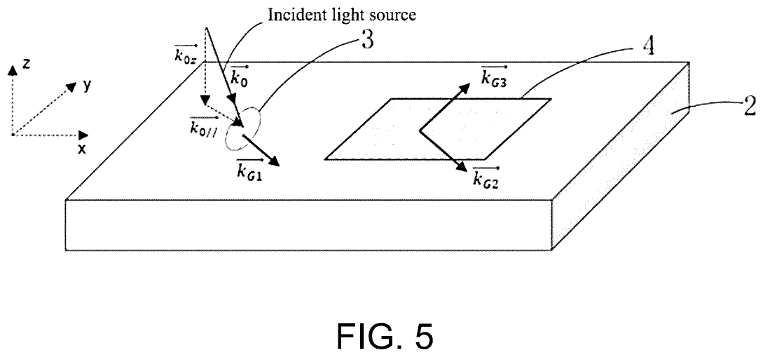

For a general grating waveguide, as shown in FIG. 5, an example is taken where a design of the grating waveguide takes an in-coupling grating 3 as a one-dimensional grating and an out-coupling grating 4 as a two-dimensional grating. Assume that the waveguide substrate 2 is located in a x-y plane, and all gratings on the surface of the waveguide substrate also lie in the x-y plane, the in-coupling grating has a grating vector \vec{k_{G1}}, and the out-coupling grating has grating vectors \vec{k_{G2}} and \vec{k_{G3}}. According to grating theory, the grating vector \vec{k_{Gt}} (where t=1, 2, 3) is a vector lying in the x-y plane, with its direction perpendicular to the grating line direction, and its magnitude is

$$\vert \vec{{k}_{Gt}} \vert = \frac{2 π}{{d}_{t}} ,$$

where dₜ is a grating period. For an incident light source carrying a vector \vec{k₀}, its interaction with the grating vector in a grating region of the grating waveguide (the in-coupling grating 3 and the out-coupling grating 4 in the figure) manifests as a change in the k-vector of the light. Each time the light interacts with the grating vector, the k-vector increases by m\vec{k_{Gt}}, where m=0, ±1, ±2, . . . , corresponding to an action order of the grating vector. Since \vec{k_{Gt}} is an in-plane vector in the x-y plane, the effect of the grating vector on the k-vector of the light only manifests as an effect on the x-y plane component of the k-vector of the light. In the figure, \vec{k₀}=\vec{k_{0z}}+\vec{k_{0//}}, that is, the \vec{k₀} vector of the incident light source usually can be decomposed into a z-direction component \vec{k_{0z}} and an in-plane component \vec{k_{0//}} in the x-y plane, and the grating only acts on \vec{k_{0//}}.

It should be noted that the analysis of the k-vector interaction of the incident light in the grating waveguide mentioned above is also applicable to the grating waveguide design where the in-coupling grating, the turning grating and the out-coupling grating each employ one-dimensional gratings.

A k-Space Representation of the Grating Waveguide:

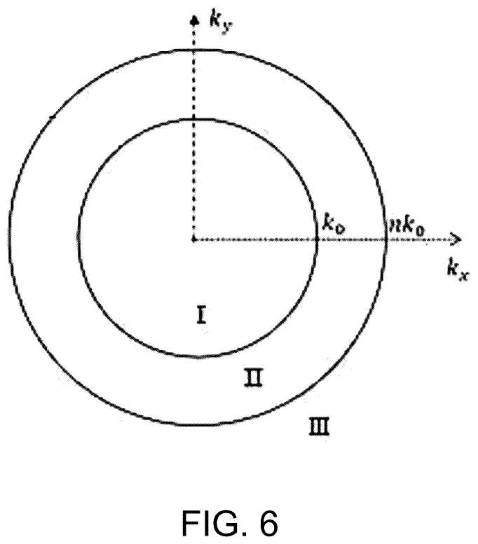

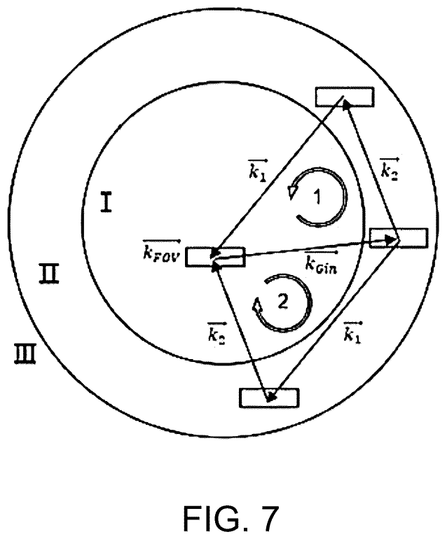

For example, FIG. 6 shows a schematic diagram of k-space of a grating waveguide when a surface of the grating waveguide lies in the x-y plane (only in-plane components parallel to the x-y plane in k-space are considered). Here, an inner circular surface represents the projection of all possible propagation states of light in air onto a kₓ-k_{y} plane, and a radius of the inner circle is k₀ as shown in the figure (the magnitude of k₀ is |\vec{k₀}|). An outer circular surface represents the projection of all possible propagation states of light in a waveguide medium with a refractive index of n on the kₓ-k_{y} plane, a radius of the outer circle is nk₀ as shown in the figure (the magnitude of nk₀ is n\vec{k₀}). In the figure, Region I represents the propagation states of light in the air. Region III represents states where light can neither propagate in the air nor in the waveguide medium with a refractive index of n, meaning no propagation states exist. Region II represents states where light cannot propagate in the air but can only propagate in the waveguide medium with a refractive index of n, meaning that the light undergoes total reflection in the waveguide medium with a refractive index of n.

The existing grating waveguide designs generally include the following several methods:

1. A grating waveguide includes a waveguide substrate. The waveguide substrate is respectively provided with an in-coupling grating, a turning grating and an out-coupling grating on the same surface (either top surface or bottom surface). The in-coupling grating, the turning grating and the out-coupling grating all employ one-dimensional gratings. Grating line regions of the in-coupling grating, the turning grating and the out-coupling grating do not overlap each other.

2. A grating waveguide includes a waveguide substrate. The waveguide substrate is respectively provided with an in-coupling grating and a turning grating on the top surface, and is provided with an out-coupling grating on the bottom surface. The in-coupling grating, the turning grating and the out-coupling grating all employ one-dimensional gratings. Grating line regions of the turning grating and the out-coupling grating have an overlapping region in space. Here, the grating structures disposed on the top and bottom surfaces of the waveguide substrate may also be interchanged.

3. A grating waveguide includes a waveguide substrate. The waveguide substrate is respectively provided with an in-coupling grating and an out-coupling grating on the same surface (either top surface or bottom surface). The in-coupling grating employs a one-dimensional grating, and the out-coupling grating employs a two-dimensional grating.

For existing grating waveguide design structures, especially for a grating line overlapping structure with multiple dimensions in the out-coupling grating region (including spatial overlapping of grating lines on different planes and overlapping of grating lines on the same plane, etc.), the grating structure receives a projected beam from an imaging device, and the grating vector of the grating structure modulates the projected beam to obtain a modulated beam. The modulated beam propagates inside the waveguide substrate or exits from inside the waveguide substrate. A propagation direction of the modulated beam inside the waveguide substrate satisfies a condition of total reflection, and the grating vectors of the grating structure form two closed paths in k-space.

An example is taken where a one-dimensional in-coupling grating and a two-dimensional out-coupling grating are respectively disposed on the same surface (either top surface or bottom surface) of the waveguide substrate, a schematic diagram of a k-space design of a conventional grating waveguide is shown in FIG. 7. In the figure, a rectangular box represents an in-plane component box of a k-vector of a field of view (FOV) projected by an optical engine in a waveguide plane. An inner circular surface represents the projection onto the waveguide plane of k-vectors for all possible propagation states of light in air, while an outer circular surface represents the projection onto the waveguide plane of k-vectors for all possible propagation states of light in a waveguide medium with a refractive index of n. \vec{k_{FOV}} represents the in-plane component of the k-vector of the FOV projected by the optical engine (imaging device) in the waveguide plane (usually it is approximately a rectangular box), \vec{k_{Gin}} is a grating vector of the in-coupling grating, \vec{k₁} and \vec{k₂} are two grating vectors of the out-coupling grating (where |\vec{kₜ}|=2π/dₜ, |\vec{kₜ}| represents the magnitude of the grating vector, dₜ is a grating period, where t=Gin, 1, 2).

As shown in the figure, when all three of the following conditions (1)-(3) are met, the propagation direction of the modulated beam within the waveguide substrate satisfies the condition of total reflection:

$$\vec{{k}_{FOV}} + \vec{{k}_{Gin}} ∈ Region II \qquad ( 1 )$$

$$\vec{{k}_{FOV}} + \vec{{k}_{Gin}} + \vec{{k}_{2}} ∈ Region II \qquad ( 2 )$$

$$\vec{{k}_{FOV}} + \vec{{k}_{Gin}} + \vec{{k}_{1}} ∈ Region II \qquad ( 3 )$$

These three grating vectors \vec{k_{Gin}}, \vec{k₁} and \vec{k₂} form two closed paths in k-space.

The purpose of the existing technology or scheme to form two closed paths with these three k-vectors \vec{k_{Gin}}, \vec{k₁} and \vec{k₂} in k-space is: during the process of using grating waveguides as AR glasses' lenses, it is necessary to ensure that the FOV projected by the optical engine (imaging device) will eventually return to its original state after being acted upon by the grating vectors of the in-coupling grating and the out-coupling grating. That is, when a projected image of the optical engine enters the eye box in the form of a projected beam through the in-coupling grating coupling waveguide and the out-coupling grating coupling waveguide, the waveguide display imaging is distortion-free and undistorted compared to the projected image of the optical engine.

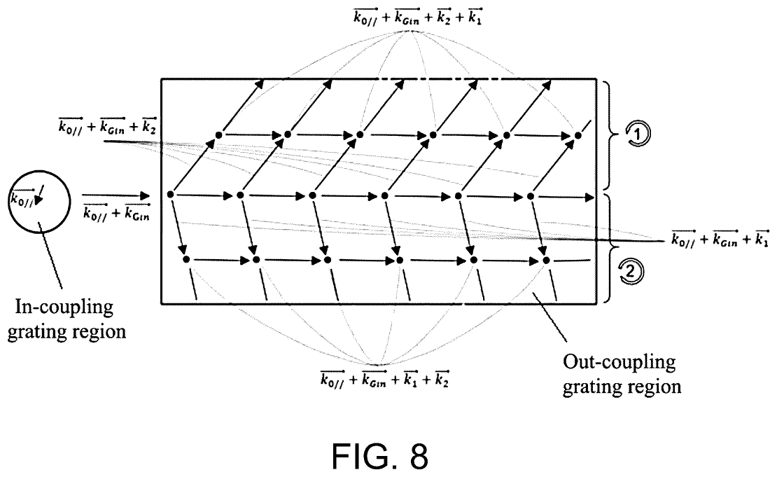

Corresponding to the k-space design of the grating waveguide shown in FIG. 7 mentioned above, taking a pixel point light source from the projected image of the optical engine (i.e., a point within the rectangular box in FIG. 7 mentioned above) as an example, a diagram of actual spatial light path propagation in the grating waveguide is shown in FIG. 8. The pixel point light source is coupled into the in-coupling grating, propagates via total reflection to the out-coupling grating, and interacts with the out-coupling grating, resulting in a dot array path shown in FIG. 8. Among them, the dot array path with upward pupil expansion in k-space mainly undergoes k-vector effect shown as the closed path 1 in FIG. 7. The specific physical process is as follows: 1. Suppose a pixel point light source carries a vector \vec{k_{0//}} and propagates along a lower left direction shown in FIG. 8, and strikes the in-coupling grating. Through a diffraction effect of the in-coupling grating, the vector \vec{k_{0//}} will increase by \vec{k_{Gin}} to become \vec{k_{0//}}+\vec{k_{Gin}}. At this time, the k-vector lies in Region II of FIG. 7, and the light propagates to the right via total reflection within the waveguide. 2. When the light propagating by total reflection reaches the out-coupling grating: the light on a main path from the in-coupling grating to the out-coupling grating, 1) part of the light is diffracted by the out-coupling grating and increases by another vector \vec{k₂}. At this time, the k-vector becomes \vec{k_{0//}}+\vec{k_{Gin}}+\vec{k₂}, and the light changes from right total reflection to upper-right direction total reflection (hence \vec{k₂} is also called a turning k-vector). When it strikes the out-coupling grating again, part of the light will undergo another diffraction and gain an additional vector \vec{k₁}. At this time, the k-vector becomes \vec{k_{0//}}+\vec{k_{Gin}}+\vec{k₂}+\vec{k₁}, that is, this part of light, in addition to its own vector \vec{k_{0//}}, has gained a total of \vec{k_{Gin}}+\vec{k₂}+\vec{k₁}=0 (closed path 1). Consequently, the light will be diffracted out of the waveguide and enter the eye box for imaging, propagating in the same state as when initially projected by the optical engine (hence \vec{k₁} is also called an out-coupling k-vector). Part of the light continues to propagate via total reflection along the upper-right direction until it strikes the out-coupling grating again, and the diffraction outcoupling process repeats. 2) The remaining light will continue to propagate via total reflection to the right and strike the out-coupling grating again. Part of the light will repeat the diffraction process in 1) while part of the light will continue to propagate via total reflection to the right, ultimately achieving the pupil expansion phenomenon with simultaneous propagation and diffraction, resulting in a dot array pattern shown in an upper half of the out-coupling grating region in FIG. 8.

Similarly, the dot array path of the downward pupil expansion in FIG. 8 mainly experiences the k-vector effect shown as the closed path 2 in FIG. 7 in k-space, and its physical process is similar to that of the closed path 1. The difference is that in this process, \vec{k₁} acts as a turning k-vector while \vec{k₂} acts as an out-coupling k-vector, resulting in a dot array pattern as shown in a lower half of the out-coupling grating region in FIG. 8. The details will not be repeated here. Light out-coupling from both the upper and lower parts of the out-coupling grating region ensures the integrity of the final imaging of light within the eye box.

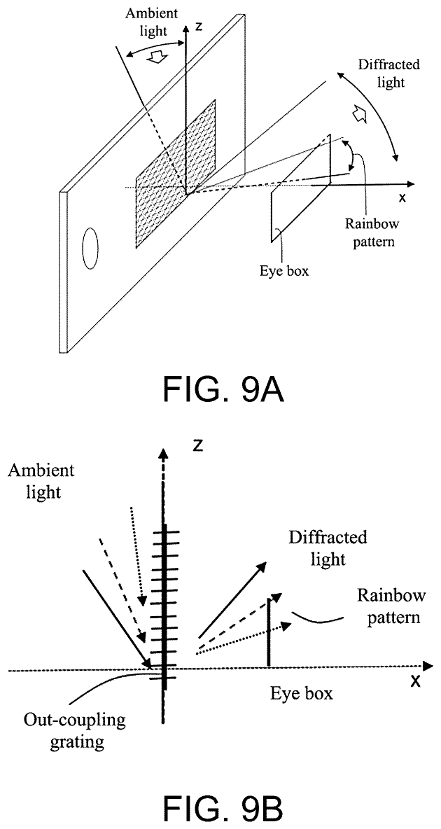

However, when using the above-mentioned existing k-space designed grating waveguide as lenses of AR glasses, when a user actually wears the AR glasses, within an eye box range, in addition to images that enter an eye box through the out-coupling of the grating waveguide from the output of the optical engine, the human eyes can usually also observe a rainbow pattern phenomenon formed by ambient light being directly diffracted into the eye box via the out-coupling grating. As an interfering background, rainbow patterns seriously affect the viewing effect of images observed by the human eyes. When the existing grating waveguide is used as AR glasses' lenses, a schematic diagram of a formation principle of the rainbow pattern phenomenon is shown in FIG. 9A. FIG. 9B is a cross-sectional view on a x-z plane of FIG. 9A. The ambient light is diffracted by the out-coupling grating, and the diffraction process is accompanied by dispersion. The part of the dispersed diffracted light that enters the eye box and is observed by the human eyes is called rainbow pattern.

Therefore, the present application provides a grating waveguide apparatus and waveguide system for reducing rainbow patterns, aiming to solve the above technical problems in the prior art.

In order to solve the problem of rainbow patterns, the present application breaks the conventional k-space design thinking of grating waveguides, the grating structure receives a projected beam of the imaging device. The grating vector modulates the projected beam to obtain a modulated beam, and the modulated beam propagates inside a waveguide substrate or exits from inside the waveguide substrate. The propagation direction of the modulated beam inside the waveguide substrate satisfies the condition of total reflection. The grating vectors of the grating structure form exactly one closed path in k-space, so that the modulated beam produced by modulation of ambient light using the grating vectors is located outside a region that can be observed by human eyes, thereby achieving an effect of avoiding rainbow patterns.

In the present application, the grating vectors of the grating structure form exactly one closed path in k-space. On the one hand, it can ensure that the FOV projected by an optical engine, after being subject to the grating vector effect of the grating structure within the waveguide substrate, will eventually return to its original state. That is, when a projected image of the optical engine enters an eye box via projected beams through the grating structure of the waveguide substrate, the image displayed by the waveguide is distortion-free and undistorted compared to the projected image of the optical engine. On the other hand, the diffracted light from the ambient light that undergoes diffraction through the grating structure will not enter the eye box region, such that within an eye box range, the human eyes can only observe the image output from the optical engine and coupled out through the waveguide into the eye box, and will not observe the rainbow pattern phenomenon formed by ambient light being directly diffracted into the eye box through the grating structure, thereby enhancing the viewing effect of the image output by the waveguide for the human eyes.

The following provides a detailed description of the technical solution of the present application and how the technical solution of the present application solves the above technical problems through specific embodiments. The following specific embodiments can be combined with each other. For the same or similar concepts or processes, they may not be elaborated in some embodiments. The following will describe the embodiments of the present application in combination with drawings.

For example, a grating structure of the present application can employ the following several schemes:

### Scheme 1:

The grating structure includes a first in-coupling grating and a first out-coupling grating.

A waveguide substrate is provided with the first in-coupling grating and the first out-coupling grating on the same surface or on different surfaces.

The first in-coupling grating employs a one-dimensional grating, a two-dimensional grating or a segmented composite grating of a one-dimensional grating and a two-dimensional grating, and the first out-coupling grating employs a two-dimensional grating.

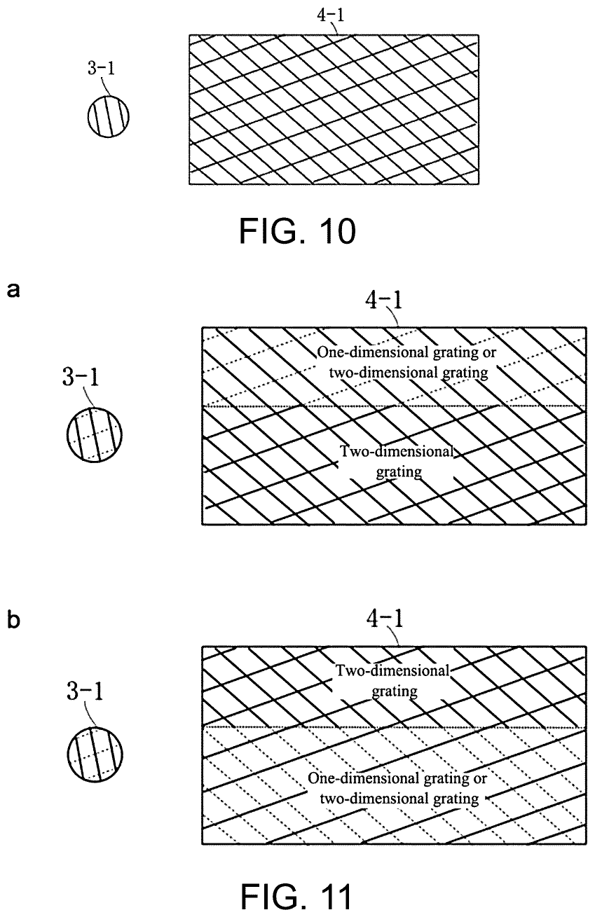

As shown in FIG. 10, it illustrates the situation where the first in-coupling grating 3-1 and the first out-coupling grating 4-1 are disposed on the same surface of the waveguide substrate, the first in-coupling grating 3-1 employs a one-dimensional grating, while the first out-coupling grating 4-1 employs a two-dimensional grating.

### Scheme 2:

The grating structure includes a first in-coupling grating and a first out-coupling grating.

A waveguide substrate is provided with the first in-coupling grating and the first out-coupling grating on the same surface or on different surfaces thereof.

The first in-coupling grating employs a one-dimensional grating, a two-dimensional grating or a segmented composite grating of a one-dimensional grating and a two-dimensional grating.

The first out-coupling grating employs a segmented composite grating of a one-dimensional grating and a two-dimensional grating, or a segmented composite grating of at least two two-dimensional gratings.

As shown in FIG. 11, it illustrates the situation where the first in-coupling grating 3-1 and the first out-coupling grating 4-1 are disposed on the same surface of the waveguide substrate, the first in-coupling grating 3-1 can employ a one-dimensional grating or a two-dimensional grating, and the first out-coupling grating 4-1 can employ a segmented composite grating of a one-dimensional grating and a two-dimensional grating or a segmented composite grating of two two-dimensional gratings.

### Scheme 3:

The grating structure includes a second in-coupling grating, a turning grating and a second out-coupling grating.

A waveguide substrate is provided with the second in-coupling grating, the turning grating and the second out-coupling grating.

The turning grating and the second out-coupling grating are located on different surfaces of the waveguide substrate and are arranged in parallel.

The second in-coupling grating can employ a one-dimensional grating, a two-dimensional grating or a segmented composite grating of a one-dimensional grating and a two-dimensional grating.

The turning grating can employ a one-dimensional grating, a two-dimensional grating or a segmented composite grating of a one-dimensional and a two-dimensional grating.

The second out-coupling grating can employ a one-dimensional grating, a two-dimensional grating or a segmented composite grating of a one-dimensional and a two-dimensional grating.

A grating line region of the turning grating and that of the second out-coupling grating have an overlapping region in space.

As shown in FIG. 12, it is illustrated that the second in-coupling grating 3-2 and the turning grating 5 are disposed on an upper surface of the waveguide substrate 2, and the second out-coupling grating 4-2 is disposed on a lower surface of the waveguide substrate 2. The second in-coupling grating 3-2, the turning grating 5 and the second out-coupling grating 4-2 all employ one-dimensional gratings, and the grating line region of the turning grating 5 and that of the second out-coupling grating 4-2 have an overlapping region in space.

With respect to the above-mentioned scheme 1 and scheme 2, the grating vectors of the first in-coupling grating and the first out-coupling grating form exactly one closed path in the k-space. For example, the first in-coupling grating has a grating vector \vec{k_{Gin1}}, and the second out-coupling grating has grating vectors \vec{k₁} and \vec{k₂}, there is only one closed path in the k-space such that \vec{k_{Gin1}}+\vec{k₂}+\vec{k₁}=0.

Specifically, a vector sum of the grating vectors \vec{k_{Gin1}}, \vec{k₁} and \vec{k₂} is 0, and a vector sum of a horizontal component of a light vector of a projected beam of an imaging device and the grating vectors \vec{k_{Gin1}} and \vec{k₁} falls outside a first projection region, and a vector sum of the horizontal component of the light vector of the projected beam and the grating vectors \vec{k_{Gin1}} and \vec{k₂} falls within the first projection region but outside a second projection region.

Among them, the horizontal component of the light vector of the projected beam of the imaging device is a component of the projected beam in a grating waveguide plane.

The first projection region is a projection onto the grating waveguide plane of a k-space vector sphere determined by a refractive index of the waveguide substrate.

The second projection region is a projection onto the grating waveguide plane of a k-space vector sphere determined by a refractive index of air.

With respect to the above-mentioned scheme 3, the grating vectors of the second in-coupling grating, the turning grating and the first out-coupling grating form exactly one closed path in the k-space. For example, the second in-coupling grating has a grating vector \vec{k_{Gin2}}, the turning grating has a grating vector \vec{k₃} and the second out-coupling grating has a grating vector \vec{k₄}. There is only one closed path in the k-space such that \vec{k_{Gin2}}+\vec{k₃}+\vec{k₄}=0.

Specifically, a vector sum of the grating vectors \vec{k_{Gin2}}, \vec{k₃} and \vec{k₄} is 0, and a vector sum of a horizontal component of a light vector of a projected beam of an imaging device and the grating vectors \vec{k_{Gin2}} and \vec{k₃} falls outside a first projection region, and a vector sum of the horizontal component of the light vector of the projected beam and the grating vectors \vec{k_{Gin2}} and \vec{k₄} falls within the first projection region but outside a second projection region.

Among them, the horizontal component of the light vector of the projected beam of the imaging device is a component of the projected beam in the grating waveguide plane.

The first projection region is a projection onto the grating waveguide plane of a k-space vector sphere determined by a refractive index of the waveguide substrate.

The second projection region is a projection onto the grating waveguide plane of a k-space vector sphere determined by a refractive index of air.

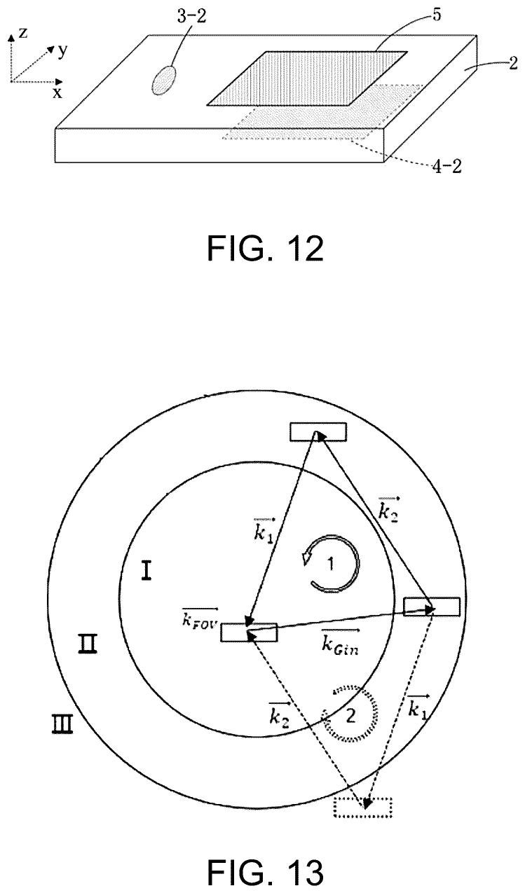

Exemplarily, an example is taken where a one-dimensional in-coupling grating and a two-dimensional out-coupling grating are respectively disposed on the same surface (either top surface or bottom surface) of the waveguide substrate, a schematic diagram of a grating waveguide's k-space design of the present application is shown in FIG. 13. In the figure, a rectangular box represents an in-plane component box of a k-vector of an FOV projected by an optical engine in a waveguide plane. An inner circular surface represents the projection onto the waveguide plane of k-vectors for all possible propagation states of light in air, while an outer circular surface represents the projection onto the waveguide plane of k-vectors for all possible propagation states of light in a waveguide medium with a refractive index of n. \vec{k_{FOV}} represents the in-plane component of the k-vector of the FOV projected by the optical engine (imaging device) in the waveguide plane, \vec{k_{Gin}} is a grating vector of the in-coupling grating, \vec{k₁} and \vec{k₂} are two grating vectors of the out-coupling grating (where |\vec{kₜ}|=2π/dₜ, |\vec{kₜ}| represents the magnitude of the grating vector, dₜ is a grating period, where t=Gin, 1, 2).

As shown in the figure, when the following condition (4) is met, the propagation directions of the modulated beams within the waveguide substrate all satisfy the condition of total reflection:

$${K}_{FOV} + {K}_{Gin} ∈ Region II , and {K}_{FOV} + {K}_{Gin} + {k}_{2} ∈ Region II , \qquad ( 4 )$$

Meanwhile, as shown in the figure, \vec{K_{FOV}}+\vec{K_{Gin}}+\vec{k₁}∈Region III (5).

The above formula (4) can also be expressed as |\vec{k₀} |<|\vec{k_{FOV}}+\vec{k_{Gin}}<n|\vec{k₀}|, and |\vec{k₀} |<|\vec{k_{FOV}}+\vec{k_{Gin}}+\vec{k₂} |<n|\vec{k₀}|.

The above formula (5) can also be expressed as |\vec{k_{FOV}}+\vec{k_{Gin}}+\vec{k₁}|>n|\vec{k₀}|.

These three grating vectors \vec{k_{Gin}}, \vec{k₁} and \vec{k₂} form one closed paths in k-space.

During the process of using grating waveguides as AR glasses' lenses, forming one closed path with these three grating vectors \vec{k_{Gin}}, \vec{k₁} and \vec{k₂} in k-space, on the one hand, ensures that the FOV projected by the optical engine (imaging device), after being subject to the grating vector effects of the in-coupling grating and the out-coupling grating, will eventually return to its original state. That is, when a projected image of the optical engine enters the eye box after the in-coupling of the in-coupling grating into the waveguide and the out-coupling of the grating out-coupling outside the waveguide, the image displayed by the waveguide is distortion-free and undistorted compared to the projected image of the optical engine. On the other hand, the diffracted light from ambient light that undergoes diffraction by the out-coupling grating will not enter the eye box region, such that within the eye box range, the human eyes can only observe an image output from the optical engine and coupled out into the eye box via the waveguide, and will not observe the rainbow pattern phenomenon formed by the ambient light being directly diffracted into the eye box through the out-coupling grating, thereby greatly enhancing the viewing effect of the image output by the waveguide for the human eyes.

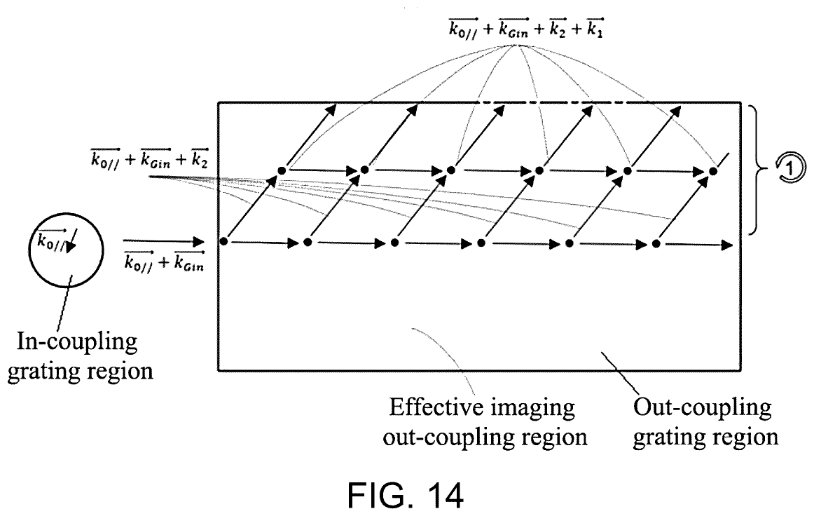

Corresponding to the k-space design of the grating waveguide shown in FIG. 13 above (as shown in FIG. 13, these three grating vectors \vec{k_{Gin}}, \vec{k₁} and \vec{k₂} form one closed path in k-space), taking a pixel point light source from the projected image of the optical engine (i.e., a point within the rectangular box in FIG. 13 above) as an example, a diagram of actual spatial light path propagation in the grating waveguide is shown in FIG. 14. The specific physical process is as follows: 1. Suppose a pixel point light source carries a vector \vec{k_{0//}} and propagates along a lower left direction shown in the figure, and strikes the in-coupling grating. Through a diffraction effect of the in-coupling grating, the vector \vec{k_{0//}} will increase by \vec{k_{Gin}} to become \vec{k_{0//}}+\vec{k_{Gin}}. At this time, the light propagates to the right via total reflection within the waveguide. 2. When the light propagating by total reflection reaches the out-coupling grating: 1) part of the light is diffracted by the out-coupling grating and increases by another vector \vec{k₂}. At this time, the k-vector becomes \vec{k_{0//}}+\vec{k_{Gin}}+\vec{k₂}, and the light changes from right total reflection to upper-right total reflection (hence \vec{k₂} is also called a turning k-vector). When it strikes the out-coupling grating again, part of the light will undergo another diffraction and gain an additional vector \vec{k₁}. At this time, the k-vector becomes \vec{k_{0//}}+\vec{k_{Gin}}+\vec{k₂}+\vec{k₁}, that is, this part of the light, in addition to its own vector \vec{k_{0//}} has gained a total of \vec{k_{Gin}}=\vec{k₂}+\vec{k₁}=0 (closed path 1). Consequently, the light will be diffracted out of the waveguide and enter the eye box for imaging, propagating in the same state as when initially projected by the optical engine (hence \vec{k₁} is also called an out-coupling k-vector). Part of the light continues to propagate via total reflection along the upper-right direction until it strikes the out-coupling grating again, and the diffraction outcoupling process repeats. 2) The remaining light will continue to propagate via total reflection to the right and strike the out-coupling grating again. Part of the light will repeat the diffraction process in 1) while part of the light will continue to propagate via total reflection to the right, ultimately achieving the pupil expansion phenomenon with simultaneous propagation and diffraction.

Compared with FIG. 8, FIG. 13 shows the case that the grating vector of the in-coupling grating and the grating vector of the out-coupling grating in the grating waveguide form only one closed path in k-space. The actual spatial light path propagation route within the grating waveguide shown in FIG. 14 only includes the closed path 1 portion shown in FIG. 8, and does not include the closed path 2 portion shown in FIG. 8. That is, the two k-vectors (\vec{k₁}, \vec{k₂}) of the out-coupling grating shown in FIG. 13 no longer play both turning and outcoupling roles as they did in FIG. 8, but \vec{k₂} only plays a turning role and \vec{k₁} only plays an outcoupling role. Moreover, since the actual spatial light path propagation route in the grating waveguide in the scheme of the present application does not include the closed path 2, the energy originally propagated through the closed path 2 will be transferred to the closed path 1. Compared with the existing technology, the energy coupling diffraction efficiency in the out-coupling grating region is improved.

In order to make the above-mentioned grating vectors of the grating structure form exactly one closed path in the k-space, illustratively, the present application achieves this by adjusting the periodic variation of the grating. The grating period of a portion of the grating structure on the waveguide substrate can be adjusted, or the grating period of the entire grating structure on the waveguide substrate can be adjusted. By adjusting the grating period of the grating structure, the above-mentioned grating vectors of the grating structure form exactly one closed path in k-space.

Taking a schematic diagram shown in FIG. 13 as an example, in which one closed path is formed in k-space by the grating vector (\vec{k_{Gin}}) of the in-coupling grating and the grating vectors (\vec{k₁}, \vec{k₂}) of the out-coupling grating in the grating waveguide, the adjustment can be mainly made to the period corresponding to the out-coupling grating's vector \vec{k₂}, and then the periods corresponding to the out-coupling grating's vector \vec{k₁} and the in-coupling grating's vector \vec{k_{Gin}} can be slightly adjusted, thereby ensuring that the in-coupling grating's vector \vec{k_{Gin}}, the out-coupling grating's vector \vec{k₁}, and the out-coupling grating's vector \vec{k₂} form a closed path with exactly one closed path in k-space.

Compared with the existing scheme in which two closed paths are formed in k-space with the above-mentioned grating vectors of the grating structure on the waveguide substrate, in the present application, forming exactly one closed path in k-space with the above-mentioned grating vectors of the grating structure on the waveguide substrate will eliminate one light path propagation in the out-coupling grating region. As shown in the comparative analysis of FIG. 14 and FIG. 8 above, the grating vector of the in-coupling grating and the grating vector of the out-coupling grating in the grating waveguide only form one closed path in the k-space in FIG. 14. The actual spatial light path propagation route in the grating waveguide shown in FIG. 14 includes only the closed path 1 portion shown in FIG. 8, and the closed path 2 portion shown in FIG. 8 no longer exists. Due to the reduction of one light path propagation route in the out-coupling grating region, there will be a problem of incomplete imaging when the projected image of the optical engine is coupled out through the waveguide and enters human eyes. As shown in FIG. 14, taking a pixel point light source in the projected image of the optical engine (i.e., a point within the rectangular box in the above FIG. 13) as an example, its effective imaging out-coupling region (i.e., the pixel point light source can successfully enter the eye box for imaging through the coupling effect of the out-coupling grating region, and this out-coupling grating region is an effective imaging out-coupling region of the pixel point light source) is the rectangular shadow region shown in FIG. 14. When human eyes observe within the entire eye box range, the problem of missing this pixel may occur. Extending this to all pixels in the projected image of the optical engine, there may be a problem of incomplete imaging when the projected image of the optical engine is coupled out through the waveguide and enters the human eyes. Therefore, this is also another reason why technicians in this field adopt a scheme of forming two closed paths in k-space, instead of one closed path, with the above-mentioned grating vectors of the grating structure on the waveguide substrate.

In order to prevent the above-mentioned problem from occurring, that is, to avoid the problem of incomplete imaging when the projected image of the optical engine is coupled out through the waveguide and enters the human eyes, in the present application, during the process of adjusting the grating period to make the grating vectors of the grating structure form exactly one closed path in k-space, the grating line direction is adjusted so that the projected image of the optical engine can be fully imaged after being coupled out of the waveguide and entering the human eyes. The grating line direction of a portion of the grating structure on the waveguide substrate may be adjusted, or the grating line direction of the entire grating structure on the waveguide substrate may be adjusted. At the same time, in order to meet the above formula (4), the grating period of the grating structure may be fine-tuned.

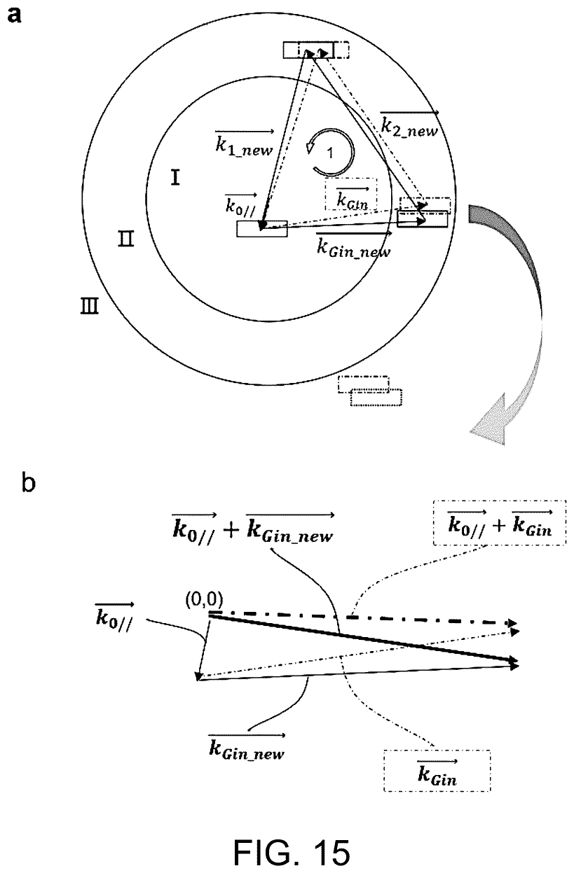

Taking the schematic diagram shown in FIG. 13 as an example, in which one closed path is formed in k-space by the grating vector (\vec{k_{Gin}}) of the in-coupling grating and the grating vectors (\vec{k₁}, \vec{k₂}) of the out-coupling grating in the grating waveguide, the adjustment can be mainly made to the grating line direction of the in-coupling grating. In addition, in order to make \vec{k_{Gin}}, \vec{k₁} and \vec{k₂} meet the requirements of closure, the grating line direction of the out-coupling grating is fine-tuned. FIG. 15 is a schematic diagram of the k-space design of the grating waveguide after further adjustment based on FIG. 13. A solid arrow in the figure represents the grating vector (\vec{k_{Gin_new}}) of the in-coupling grating and the grating vectors (\vec{k_{1_new}}, \vec{k_{2_new}}) of the out-coupling grating after adjustment of the grating line direction. A dashed arrow corresponds to the grating vector (\vec{k_{Gin}}) of the in-coupling grating and the grating vectors (\vec{k₁}, \vec{k₂}) of the out-coupling grating before the adjustment of the grating line direction. Figure a in FIG. 15 shows the case in which the grating line direction of the in-coupling grating is changed and then the direction of \vec{k_{Gin}} is changed, such that \vec{k_{Gin}} is turned clockwise by a small angle and becomes \vec{k_{0//}}+\vec{k_{Gin}} to \vec{k_{0//}}+\vec{k_{Gin_new}}. In this way, the in-plane propagation direction when coming out from the in-coupling grating and entering into the out-coupling grating is adjusted from the original \vec{k_{0//}}+\vec{k_{Gin}} to \vec{k_{0//}}+\vec{k_{Gin_new}}. Figure b in FIG. 15 is an enlarged view of the adjustment to the grating vector of the in-coupling grating in Figure a. It can be clearly seen that the adjusted direction of \vec{k_{0//}}+\vec{k_{Gin_new}} is lower than the direction of \vec{k_{0//}}+\vec{k_{Gin}} before the adjustment.

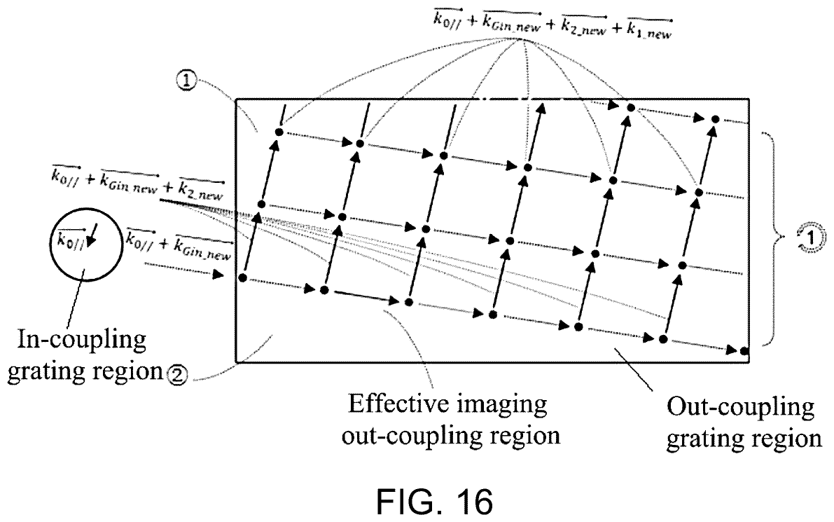

Corresponding to the k-space design of the grating waveguide shown in FIG. 15 above (i.e., as shown in FIG. 15, the three grating vectors \vec{k_{Gin_new}}, \vec{k_{1_new}} and \vec{k_{2_new}}, form a closed path in k-space), taking a central pixel point light source in the projected image of the optical engine (i.e., the center point within the rectangular box in FIG. 15 above) as an example, the actual spatial light path propagation route within the grating waveguide is shown in FIG. 16. By comparing FIG. 16 with FIG. 14, it can be seen that an out-coupling dot array in FIG. 16 covers the effective imaging out-coupling region of the pixel point light source (i.e., the rectangular shadow region in FIG. 16), so the human eyes can observe this pixel point light source throughout the entire eye box range. Similarly, other pixel point light sources in the projected image of the optical engine can be subject to similar optimal adjustments, thereby ensuring that the projected image of the optical engine can be fully displayed after being coupled out through the waveguide and entering the human eyes.

Moreover, during the fine-tuning of the grating line direction of the out-coupling grating, for certain pixel point light sources in the projected image of the optical engine (imaging device), the effective imaging out-coupling region may be shown in Region \textcircled{1} as indicated in FIG. 16. When human eyes observe throughout the entire eye box, the problem of missing pixel(s) may also occur. At this time, the grating line direction of the out-coupling grating can be further adjusted to regulate the out-coupling grating's vectors \vec{k₁} and \vec{k₂}, making the direction of \vec{k_{0//}}+\vec{k_{Gin_new}}+\vec{k_{2_new}} closer to Region \textcircled{1} (\vec{k_{0//}}+\vec{k_{Gin_new}}+\vec{k_{2_new}} in the figure a in FIG. 15). Similarly, for some pixel point light sources, the effective imaging out-coupling region may be shown in Region \textcircled{2} as indicated in FIG. 16. To avoid the problem of missing imaging of this pixel, the grating line direction of the in-coupling grating can be further adjusted to regulate the in-coupling grating's vector \vec{k_{Gin}}, making the direction of \vec{k_{0//}}+\vec{k_{Gin_new}} more downward and closer to Region \textcircled{2}.

Furthermore, it should be noted that, with respect to the k-space design of the existing grating waveguide shown in FIG. 7 (in which the grating vectors of the grating structure form two closed paths in k-space), due to other higher-order effects of the out-coupling grating, the rectangular box will form a ghost in Region I. In the present application, by making the grating vectors of the grating structure form exactly one closed path in k-space (as shown in FIG. 13), no ghost will be formed in Region I.

In addition, for the grating structure shown in FIG. 10 used in the present application, in some embodiments, a grating region of the first out-coupling grating is positioned above a pupil in a horizontal viewing direction, and in some embodiments, a projected beam is incident upon the grating region of the first in-coupling grating in an oblique downward direction. Alternatively, the grating region of the first out-coupling grating is positioned below a pupil in a horizontal viewing direction, and a projected beam enters the grating region of the first in-coupling grating in an oblique upward direction.

For the grating structure shown in figure a of FIG. 11 used in the present application, in some embodiments, a grating region of the first out-coupling grating is positioned above the pupil in the horizontal viewing direction, and in some embodiments, a projected beam is incident upon the grating region of the first in-coupling grating in the oblique downward direction.

For the grating structure shown in figure b of FIG. 11 used in the present application, in some embodiments, a grating region of the first out-coupling grating is positioned below the pupil in the horizontal viewing direction, and in some embodiments, a projected beam is incident upon the grating region of the first in-coupling grating in the oblique upward direction.

For the grating structure shown in FIG. 12 used in the present application, in some embodiments, an overlapping region of the grating lines of the second out-coupling grating and the turning grating is positioned above a pupil in a horizontal viewing direction, and in some embodiments, a projected beam is incident upon a grating region of the second in-coupling grating in an oblique downward direction. Alternatively, the overlapping region of the grating lines of the second out-coupling grating and the turning grating is positioned below the pupil in the horizontal viewing direction, and the projected beam is incident upon the grating region of the second in-coupling grating in the oblique upward direction.

The above operation further expands an adjustable range of the grating structure and thus makes it easier to optimize the rainbow pattern phenomenon. That is, the diffracted light from the ambient light that undergoes diffraction through the grating structure will not enter the eye box region, such that within the eye box range, the human eyes can only observe the image output from the optical engine and coupled out into the eye box via the waveguide, and will not observe the rainbow pattern phenomenon formed by ambient light being directly diffracted into the eye box through the grating structure, thereby enhancing the viewing effect of the image output by the waveguide for the human eyes.

It should be further explained that the oblique incidence of the projected beam in the technical solution of the present application is only an alternative solution. For the grating structures shown in FIG. 10 and FIG. 11, the technical solution of the present application is also applicable to the situation where the grating region of the out-coupling grating is positioned in a pupil's horizontal viewing direction and a projected beam is incident upon the grating region of the in-coupling grating in a normal incident direction. For the grating structure shown in FIG. 12, the technical solution of the present application is also applicable to the situation where the overlapping region of the grating lines of the out-coupling grating and the turning grating is positioned in the pupil's horizontal direction, and the projected beam strikes the grating region of the in-coupling grating in the normal incident direction.

The present application also provides a waveguide system, including a grating waveguide apparatus. Among them, the grating waveguide apparatus employs the aforementioned grating waveguide apparatus for reducing rainbow patterns. For instance, a type of AR glasses, lenses of which employ the aforementioned grating waveguide apparatus for reducing rainbow patterns.

The above description is merely the specific implementation mode of the present application. However, the scope of protection of the present application is not limited to this. Any change or replacement that a person familiar with the technical field can easily think of within the technical scope disclosed by the present application should be covered within the scope of protection of the present application. Therefore, the scope of protection of the present application shall be defined by the scope of protection of the claims stated.

What is claimed is:

1. A grating waveguide apparatus for reducing rainbow patterns, wherein the apparatus comprises a waveguide substrate and a grating structure, and the grating structure is arranged on the waveguide substrate;
the grating structure comprises a first in-coupling grating and a first out-coupling grating, a grating region of the first out-coupling grating has a grating line overlapping structure with multiple dimensions; grating vectors of the first in-coupling grating and the first out-coupling grating form exactly one closed path in k-space;
or,
the grating structure comprises a second in-coupling grating, a turning grating and a second out-coupling grating, a grating line region of the turning grating and a grating line region of the second out-coupling grating have an overlapping region; grating vectors of the second in-coupling grating, the turning grating and the second out-coupling grating form exactly one closed path in k-space.

2. The grating waveguide apparatus for reducing rainbow patterns according to claim 1, wherein in the case where the grating structure comprises the first in-coupling grating and the first out-coupling grating:
the waveguide substrate is provided with the first in-coupling grating and the first out-coupling grating on a same surface or on different surfaces;
the first in-coupling grating is configured as a one-dimensional grating, a two-dimensional grating or a segmented composite grating of a one-dimensional grating and a two-dimensional grating;
the first out-coupling grating is configured as a two-dimensional grating, or a segmented composite grating of a one-dimensional grating and a two-dimensional grating.

3. The grating waveguide apparatus for reducing rainbow patterns according to claim 2, wherein the two-dimensional grating is configured as a single two-dimensional grating, or a segmented composite grating of at least two two-dimensional gratings.

4. The grating waveguide apparatus for reducing rainbow patterns according to claim 2, wherein the first in-coupling grating has a grating vector \vec{k_{Gin1}}, and the second out-coupling grating has grating vectors \vec{k₁} and \vec{k₂};
a vector sum of the grating vectors \vec{k_{Gin1}}, \vec{k₁} and \vec{k₂} is 0, and a vector sum of a horizontal component of a light vector of a projected beam of an imaging device and the grating vectors \vec{k_{Gin1}} and \vec{k₁} falls outside a first projection region, and a vector sum of the horizontal component of the light vector of the projected beam and the grating vectors \vec{k_{Gin1}} and \vec{k₂} falls within the first projection region but outside a second projection region.

5. The grating waveguide apparatus for reducing rainbow patterns according to claim 2, wherein a value of a grating period is configured such that the grating vectors of the first in-coupling grating and the first out-coupling grating form exactly one closed path in the k-space; and,
a grating line direction is configured such that a projected beam of an imaging device is coupled out through the grating waveguide apparatus and enters human eyes for complete display.

6. The grating waveguide apparatus for reducing rainbow patterns according to claim 2, wherein a grating region of the first out-coupling grating is positioned above a pupil in a horizontal viewing direction, a projected beam of an imaging device is incident upon the grating region of the first in-coupling grating in an oblique downward direction.

7. The grating waveguide apparatus for reducing rainbow patterns according to claim 2, wherein a grating region of the first out-coupling grating is positioned below a pupil in a horizontal viewing direction, a projected beam of an imaging device is incident upon the grating region of the first in-coupling grating in an oblique upward direction.

8. The grating waveguide apparatus for reducing rainbow patterns according to claim 2, wherein a grating region of the out-coupling grating is positioned in a horizontal viewing direction of a pupil, a projected beam of an imaging device is incident upon the grating region of the in-coupling grating in a normal incident direction.

9. The grating waveguide apparatus for reducing rainbow patterns according to claim 1, wherein in the case where the grating structure comprises the second in-coupling grating, the turning grating and the second out-coupling grating:
the turning grating and the second out-coupling grating are located on different surfaces and are arranged in parallel;
the second in-coupling grating is configured as a one-dimensional grating, a two-dimensional grating or a segmented composite grating of a one-dimensional grating and a two-dimensional grating;
the turning grating is configured as a one-dimensional grating, a two-dimensional grating or a segmented composite grating of a one-dimensional and a two-dimensional grating;
the second out-coupling grating is configured as a one-dimensional grating, a two-dimensional grating or a segmented composite grating of a one-dimensional and a two-dimensional grating;
the grating line region of the turning grating and the grating line region of the second out-coupling grating have an overlapping region in space.

10. The grating waveguide apparatus for reducing rainbow patterns according to claim 9, wherein the second in-coupling grating has a grating vector \vec{k_{Gin2}}, the turning grating has a grating vector \vec{k₃} and the second out-coupling grating has a grating vector \vec{k₄};
a vector sum of the grating vectors \vec{k_{Gin2}}, \vec{k₃} and \vec{k₄} is 0, and a vector sum of a horizontal component of a light vector of a projected beam of an imaging device and the grating vectors \vec{k_{Gin2}} and \vec{k₃} falls outside a first projection region, and a vector sum of the horizontal component of the light vector of the projected beam and the grating vectors \vec{k_{Gin2}} and \vec{k₄} falls within the first projection region but outside a second projection region.

11. The grating waveguide apparatus for reducing rainbow patterns according to claim 9, wherein a value of a grating period is configured such that the grating vectors of the second in-coupling grating, the turning grating and the second out-coupling grating form exactly one closed path in the k-space; and,
a grating line direction is configured such that a projected beam of an imaging device is coupled out through the grating waveguide apparatus and enters human eyes for complete display.

12. The grating waveguide apparatus for reducing rainbow patterns according to claim 9, wherein an overlapping region of the grating lines of the second out-coupling grating and the turning grating is positioned above a pupil in a horizontal viewing direction, a projected beam of an imaging device is incident upon a grating region of the second in-coupling grating in an oblique downward direction.

13. The grating waveguide apparatus for reducing rainbow patterns according to claim 9, wherein an overlapping region of the grating lines of the second out-coupling grating and the turning grating is positioned below a pupil in a horizontal viewing direction, a projected beam of an imaging device is incident upon a grating region of the second in-coupling grating in an oblique upward direction.

14. The grating waveguide apparatus for reducing rainbow patterns according to claim 9, wherein an overlapping region of the grating lines of the second out-coupling grating and the turning grating is positioned in a horizontal viewing direction of a pupil, a projected beam of an imaging device is incident upon a grating region of the second in-coupling grating in a normal incident direction.

15. The grating waveguide apparatus for reducing rainbow patterns according to claim 4, wherein the horizontal component of the light vector of the projected beam of the imaging device is a component of the projected beam in a grating waveguide plane;
the first projection region is a projection onto the grating waveguide plane of a k-space vector sphere determined by a refractive index of the waveguide substrate;
the second projection region is a projection onto the grating waveguide plane of a k-space vector sphere determined by a refractive index of air.

16. The grating waveguide apparatus for reducing rainbow patterns according to claim 10, wherein the horizontal component of the light vector of the projected beam of the imaging device is a component of the projected beam in a grating waveguide plane;
the first projection region is a projection onto the grating waveguide plane of a k-space vector sphere determined by a refractive index of the waveguide substrate;
the second projection region is a projection onto the grating waveguide plane of a k-space vector sphere determined by a refractive index of air.

17. The grating waveguide apparatus for reducing rainbow patterns according to claim 1, wherein the grating vector of the first out-coupling grating has a magnitude configured such that a modulated beam resulting from modulating ambient light is directed outside a region observable by human eyes, or the grating vectors of the turning grating and the second out-coupling grating have magnitudes configured such that a modulated beam resulting from modulating ambient light is directed outside a region observable by human eyes.

18. A waveguide system, comprising a grating waveguide apparatus;
wherein the grating waveguide apparatus comprises a waveguide substrate and a grating structure, and the grating structure is arranged on the waveguide substrate;
the grating structure comprises a first in-coupling grating and a first out-coupling grating, a grating region of the first out-coupling grating has a grating line overlapping structure with multiple dimensions; grating vectors of the first in-coupling grating and the first out-coupling grating form exactly one closed path in k-space;
or,
the grating structure comprises a second in-coupling grating, a turning grating and a second out-coupling grating, a grating line region of the turning grating and a grating line region of the second out-coupling grating have an overlapping region; grating vectors of the second in-coupling grating, the turning grating and the second out-coupling grating form exactly one closed path in k-space.

19. The waveguide system according to claim 18, wherein in the case where the grating structure comprises the first in-coupling grating and the first out-coupling grating:
the waveguide substrate is provided with the first in-coupling grating and the first out-coupling grating on a same surface or on different surfaces;
the first in-coupling grating is configured as a one-dimensional grating, a two-dimensional grating or a segmented composite grating of a one-dimensional grating and a two-dimensional grating;
the first out-coupling grating is configured as a two-dimensional grating, or a segmented composite grating of a one-dimensional grating and a two-dimensional grating.

20. The waveguide system according to claim 18, wherein in the case where the grating structure comprises the second in-coupling grating, the turning grating and the second out-coupling grating:
the turning grating and the second out-coupling grating are located on different surfaces and are arranged in parallel;
the second in-coupling grating is configured as a one-dimensional grating, a two-dimensional grating or a segmented composite grating of a one-dimensional grating and a two-dimensional grating;
the turning grating is configured as a one-dimensional grating, a two-dimensional grating or a segmented composite grating of a one-dimensional and a two-dimensional grating;
the second out-coupling grating is configured as a one-dimensional grating, a two-dimensional grating or a segmented composite grating of a one-dimensional and a two-dimensional grating;
the grating line region of the turning grating and the grating line region of the second out-coupling grating have an overlapping region in space.
